(19) United States
(12) Patent Application Publication
(10) Pub. No.: US 2011/0133432 A1
(43) Pub. Date: Jun. 9, 2011

(54) HITCH ASSEMBLY WITH A SWIVEL PLATE AND METHOD FOR USING THE SAME

(76) Inventor: Robert James NORDICK, Horace, ND (US)

(21) Appl. No.: 12/959,741

(22) Filed: Dec. 3, 2010

Related U.S. Application Data
(60) Provisional application No. 61/266,718, filed on Dec. 4, 2009.

(51) Int. Cl. B60D 1/07

(52) U.S. Cl. 280/504

(57) ABSTRACT

Disclosed herein is a hitch assembly that can be used for connecting a trailer to a towing vehicle. The hitch assembly includes a support member for connecting the hitch assembly to the vehicle, a swivel plate having at least two wings, each of which has a hitch member hole extending therethrough. Each hitch member hole is sized to allow a hitch connection member to be mounted thereto. The hitch assembly further includes an L-shaped member that secures the swivel plate to the support member and a locking mechanism for releasably engaging the swivel plate such that the swivel plate can rotate relative to the support member to allow a selected wing to move into a towing position, wherein when one connection member is in use, the other connection member does not interfere with operation of the hitch assembly.

### FIELD

This disclosure relates generally to towing devices, and particularly, but not by way of limitation, to a hitch assembly with a swivel plate and a method for making the same.

### BACKGROUND

Various trailer hitches are used on the market for coupling a towing vehicle to a trailer, e.g., camp trailers, mobile homes, and the like. The trailer hitch is attached to a vehicle and typically includes a hitch ball positioned at an appropriate height off the ground to engage the tongue of the trailer. A coupler at the end of the trailer tongue fits over the hitch ball and locks into place, allowing the vehicle and trailer to pivot in relation to each other, for example, when making turns, but prevents separation.

The coupler on the trailer tongue and the hitch ball are available in different sizes, and it is necessary to match the size of the coupler and the hitch ball, to ensure proper operation during towing. Accordingly, when switching from one trailer to the next, it is often necessary for the driver of the vehicle to switch the hitch ball, to accommodate the size of the trailer's coupler. One method of facilitating the switch from one size hitch ball to another has been to provide a ball hitch assembly having multiple hitch balls.

There is a need for an improved trailer hitch that is easy to operate, that is, easy to change from one hitch ball to another and easy to connect to a trailer.

### SUMMARY

Disclosed herein is a hitch assembly that can be used for connecting a trailer to a towing vehicle. The hitch assembly includes a support member for connecting the hitch assembly to the vehicle, a swivel plate having at least two wings, each of which has a hitch member hole extending therethrough. Each hitch member hole is sized to allow a hitch connection member to be mounted thereto. The hitch assembly further includes an L-shaped member that secures the swivel plate to the support member and a locking mechanism for releasably engaging the swivel plate such that the swivel plate can rotate relative to the support member to allow a selected wing to move into a towing position, wherein when one connection member is in use, the other connection member does not interfere with operation of the hitch assembly.

In one embodiment, the hitch connection member can be a ball type including a ball portion and a shank portion, where a size of the ball portion is determined by load bearing requirements. It is to be understood that the swivel plate can include more than two wings each including a hitch member hole sized for a connection member to be mounted thereto. It is also to be understood that one hitch member hole can be left empty for generic usages.

It is to be understood that a variety of L-shaped members can be offered to accommodate variations in the height of the vehicle and trailer to provide level towing.

This Summary is an overview of some of the teachings of the present application and not intended to be an exclusive or exhaustive description of the claimed invention. Further details about the present subject matter are found in the detailed description and appended claims. Other aspects of the subject matter will be apparent to persons skilled in the art upon reading and understanding the following detailed description and viewing the drawings that form a part thereof, each of which is not to be taken in a limiting sense. The scope of the claimed invention is defined by the appended claims and their equivalents.

### DESCRIPTION OF THE DRAWINGS

The drawings, which are not necessarily drawn to scale, illustrate generally, by way of example, but not by way of limitation, various embodiments discussed in this application.

FIG. 1A illustrates an exploded view of one embodiment of a hitch assembly with a swivel plate.

FIG. 1B illustrates a perspective view of the hitch assembly of FIG. 1A.

FIG. 1C illustrates a side view of the hitch assembly of FIG. 1B.

FIG. 1D illustrates a bottom view of the hitch assembly of FIG. 1B.

FIG. 1E illustrates a side view of the hitch assembly of FIG. 1B with a hitch ball mounted on a wing of the swivel plate.

FIG. 2A illustrates a top view of an embodiment of the swivel plate.

FIG. 2B illustrates a top view of a further embodiment of the swivel plate.

FIG. 3A illustrates an exploded view of another embodiment of the hitch assembly with a swivel plate.

FIG. 3B illustrates a perspective view of the hitch assembly of FIG. 3A.

FIG. 3C illustrates a side view of the hitch assembly of FIG. 3B.

FIG. 3D illustrates a bottom view of the hitch assembly of FIG. 3B.

### DETAILED DESCRIPTION

In the following detailed description, reference is made to the accompanying drawings which form a part thereof, and in which is shown by way of illustration specific embodiments in which the inventive concepts may be practiced. These embodiments are described in sufficient detail to enable those skilled in the art to practice the invention, and it is to be understood that the embodiments may be combined or used separately, or that other embodiments may be utilized and that structural and procedural changes may be made without departing from the spirit and scope of the inventive concepts. The following detailed description provides examples, and the scope of the present invention is defined by the claims to be added and their equivalents.

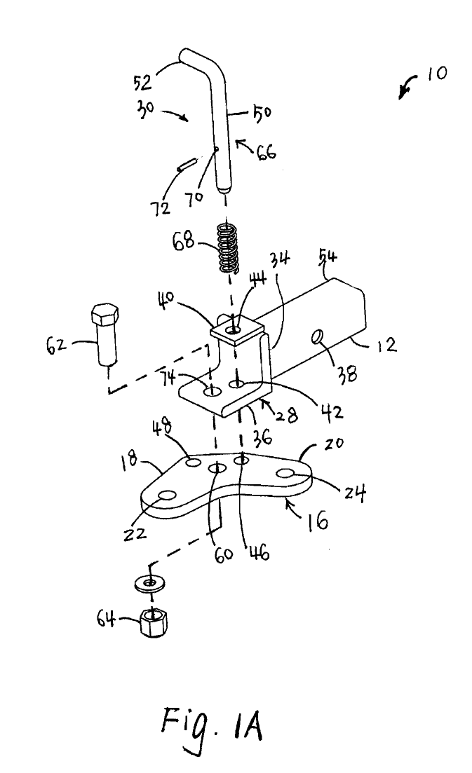

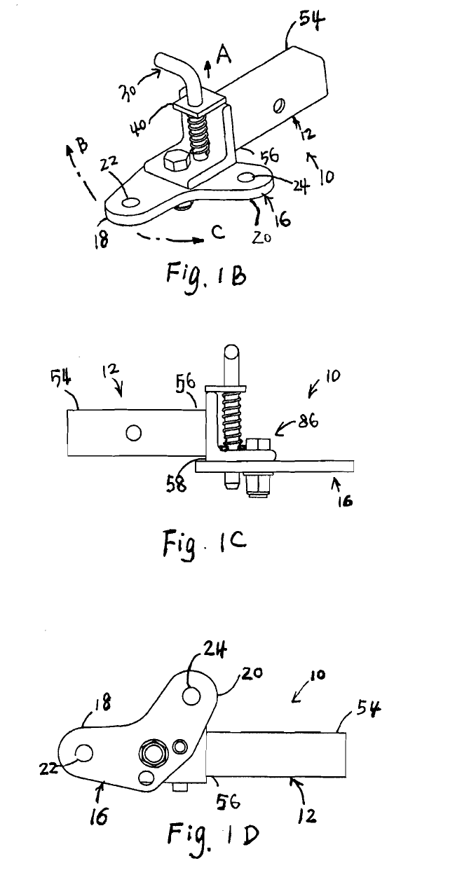

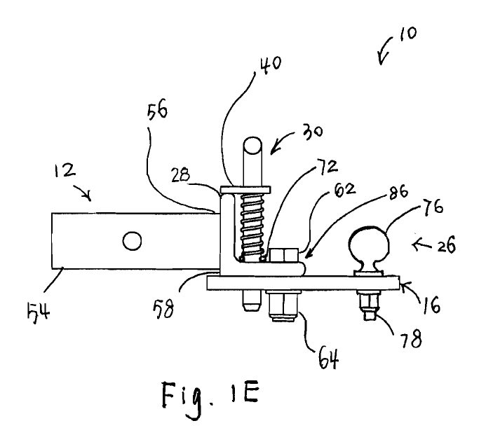

The terms “above,” “on,” “under,” “top,” “bottom,” “up,” “down,” “horizontal,” “vertical” and the like used herein are in reference to the relative positions of the hitch assembly and its constituent parts, in use when oriented as in FIGS. 1A-E, 2A-B and 3A-D.

Disclosed herein is a hitch assembly that can be used for connecting a trailer to a towing vehicle. The hitch assembly includes a support member for connecting the hitch assembly to the vehicle, a swivel plate having at least two wings, each of which has a hitch member hole extending therethrough. Each hitch member hole is sized to allow a hitch connection member to be mounted thereto. The hitch assembly further includes an L-shaped member that secures the swivel plate to the support member and a locking mechanism for releasably engaging the swivel plate such that the swivel plate can rotate relative to the support member to allow a selected wing to move into a towing position, wherein when one connection member is in use, the other connection member does not interfere with operation of the hitch assembly.

With reference to FIGS. 1A-E, in one embodiment, a hitch assembly 10 includes a support member 12 for connecting the hitch assembly 10 to a towing vehicle (not shown), a swivel plate 16 having at least two wings 18, 20, each of which has a hitch member hole 22, 24 extending therethrough. Each hitch hole 22, 24 is sized to allow a respective hitch connection member 26, 27 (not shown) to be respectively mounted thereto. The hitch assembly 10 further includes an L-shaped member 12 that secures the swivel plate 16 to the support member 12, and a locking mechanism 30 for releasably engaging the swivel plate 16 such that, when the locking mechanism 30 is released from the swivel plate 16, the swivel plate 16 can rotate relative to the support member 12 to allow a selected wing 18, 20 to move into a towing position.

With reference to FIGS. 1A-E, the support member 12 has a generally tubular, square shaped cross-section. As shown in FIG. 1C, the support member 12 includes a first end 54 sized and adapted to be coupled to a receiver (not shown) on the rear of the towing vehicle (not shown). A pair of horizontal through holes 38 are defined on left and right sides of the support member 12 to allow the support member 12 to be retained to the receiver (not shown) by a locking device, for example, a slide pin (not shown) or other locking devices. It is to be understood that the support member 12 can also be welded, bolted or otherwise fastened to the rear of the towing vehicle. The support member 12 also includes a second end 56 opposite to the first end 54 for connecting the L-shaped member 28 to the support member 12. It is to be understood that the support member 12 can be constructed in various forms as desired. In one embodiment, the support member 12 is hollow and has a 2″ by 2″ square cross-section. In another embodiment, the support member 12 can be made of a solid material.

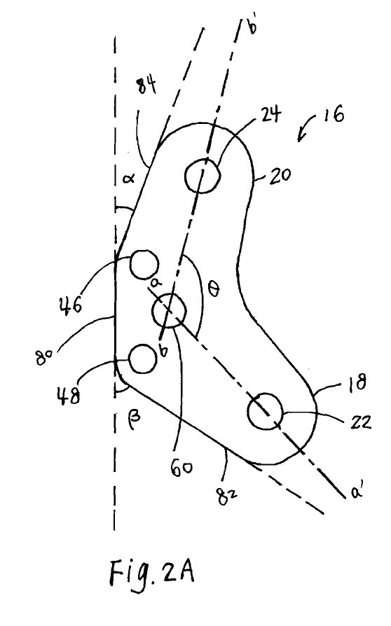

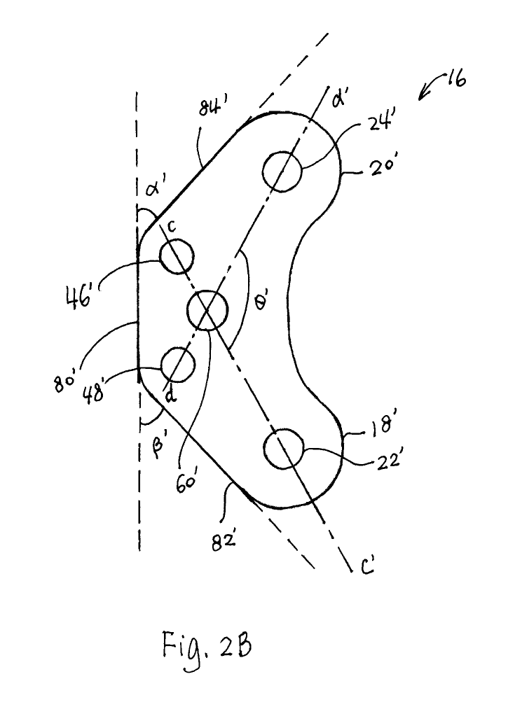

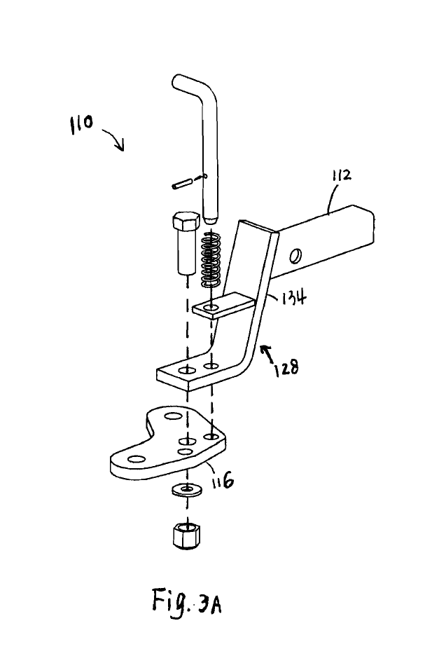

With reference to FIGS. 1A-E and FIG. 2A, the swivel plate 16 extends in a horizontal orientation and includes at least two wings 18, 20. Each wing 18, 20 includes a hitch member hole 22, 24 extending therethrough for a hitch connection member 26, 27 (27 not shown) to be mounted thereto.

As shown in FIG. 2A, the swivel plate 16 also includes an axle hole 60 at an approximately central portion of the swivel plate 16 and two position holes 46, 48 on an opposite side of the axle hole 60 with respect to the hitch member holes 22, 24, respectively. With this arrangement, a hitch connection member 26 is placed in a towing position as shown in FIG. 1E, where the hitch connection member 26 faces away from the rear of the towing vehicle and is aligned to receive a matching trailer coupler on a tow bar connected to a trailer (not shown).

With reference to FIG. 2A, lines a-a′ and b-b′ are oriented at an angle θ. It is to be understood that the angle θ can vary depending on load bearing requirements, as long as when one connection member is in use, the other connection member does not interfere with the operation of the hitch assembly. In one embodiment, lines a-a′ and b-b′ are oriented at an obtuse angle, for example, at approximately 120 degrees. This allows the hitch assembly to have a good load bearing capacity and at the same time, avoids the interference of the other hitch connection member to the towing hitch connection member. With reference to FIG. 2A, the swivel plate 16 also includes three straight sides 80, 82, 84 adjacent to each other, wherein side 84 is at an angle α with respect to the extension of side 80 and side 82 is at an angle β with respect to the extension of side 80. It is to be understood that angles α, β can vary as desired. In one embodiment, angle α equals angle β.

One example of the configuration having angle α being equal to angle β is illustrated in FIG. 2B. As shown in FIG. 2B, the swivel plate 16 includes an axle hole 60′ at an approximately central portion of the swivel plate 16 and two position holes 46′, 48′ on an opposite side of the axle hole 60′ with respect to the hitch member holes 22′, 24′, respectively. With this arrangement, a hitch connection member 26 is placed in a towing position as shown in FIG. 1E, where the hitch connection member 26 faces away from the rear of the towing vehicle and is aligned to receive a matching trailer coupler on a tow bar connected to a trailer (not shown).

With further reference to FIG. 2B, lines c-c′ and d-d′ are oriented at an angle θ′. It is to be understood that the angle θ′ can vary depending on load bearing requirements, as long as when one connection member is in use, the other connection member does not interfere with the operation of the hitch assembly. In one embodiment, lines c-c′ and d-d′ are oriented at an obtuse angle, for example, at approximately 120 degrees. With reference to FIG. 2B, the swivel plate 16 also includes three straight sides 80′, 82′, 84′ adjacent to each other, wherein side 84′ is at an angle α′ with respect to the extension of side 80′ and side 82′ is at an angle β with respect to the extension of side 80′. In this embodiment, angle α′ equals angle β′. In one embodiment, the position hole 46′, axle hole 60′ and hitch member hole 22′ are positioned approximately in line c-c′ and the position hole 48′, axle hole 60′ and hitch member hole 24′ are positioned approximately in line d-d′.

With respect to FIG. 1C, a thickness of the swivel plate 16 is selected to provide the desired strength and resistance to the stress introduced to towing a trailer (not shown). By way of example, the thickness of swivel plate may range from ½″ to ¾″.

The hitch connection members 26, 27 are rigidly secured to an upper of the swivel plate 16 to provide a mounting point for a trailer tongue of the trailer (not shown). The hitch connection member 26, 27 (not shown) can be of a ball type. However, it is to be understood that any suitable connection members may be utilized. With reference to FIG. 1E, the hitch connection member 26 or 27 (not shown) includes a ball portion 76 and a shank portion 78 having a threaded bottom end, where the shank portion is sized to extend through the hitch member holes 22 or 24. A diametric size of the ball portion 76 may vary, for example, from 1⅞″ to 2 5/16″, depending on requirements of different towing applications. It is preferable that the ball portions 76 for hitch connection members 26, 27 (not shown) have different diameters for use with a variety of trailers. In one embodiment, a large size hitch connection member and a smaller size hitch connection member can be attached to the wings 18, 20. By way of example, the ball portions 76 for the hitch connection members 26, 27 (not shown) may be 1⅞″ and 2″ in diameter. Each hitch connection member is removable and replaceable and can be reoriented depending on load bearing requirements. In an alternative embodiment, the hitch connection member can be integral with the swivel plate 16, if desired. In a further embodiment, one or more hitch member holes can be left empty for other usages.

When the hitch connection member 26 is mounted to the swivel plate 16, the ball portion 76 is positioned at an upper surface of the swivel plate 16 and the shank portion 78 extends through the hitch member hole 22 or 24 in the swivel plate 16. The hitch connection member 26 further includes a nut threaded onto the threaded end of the shank portion 78 and tightened against a lower surface of the swivel plate 16 for securing the hitch connection member 26 to the swivel plate 16. Likewise, the hitch connection member 27 (not shown) can be secured to the other hitch member hole. By this, each hitch connection member 26, 27 (not shown) is securely fastened to the swivel plate 16. Alternatively, each hitch connection member 26, 27 (not shown) can be secured to the swivel plate 16 by welding.

With reference to FIGS. 1A-E, the hitch assembly 10 further includes an L-shaped member 28 having an upright arm 34 and a bottom arm 36, where the upright arm 34 is oriented at a substantially right angle relative to the bottom arm 36. An axle hole 74 is defined in the bottom arm 36.

With reference to FIG. 1C, the swivel plate 16 is connected to the support member 12 through the L-shaped member 28. On one hand, the second end 56 of the support member 12 is secured to a back surface of the upright arm 34. On the other hand, the swivel plate 16 is rotatably attached in a general horizontal orientation to a lower surface of the bottom arm 36 by a mounting mechanism 86, which allows rotation of the swivel plate 16 relative to the bottom arm 36.

The mounting mechanism 86 includes a bolt 62 having a threaded end and a nut 64. To mount the swivel plate 16 to the L-shaped member 28, the bolt 62 is inserted into the axle hole 74 in the bottom arm 36 and passes into the axle hole 60 of the swivel plate 16 and out of the lower surface of the swivel plate 16. When the swivel plate 16 is properly positioned such that the wing 18 or 20 is oriented in a towing position, the nut 64 is threaded onto the threaded end of the bolt 62 and tightened against the lower surface of the swivel plate 16 to retain the swivel plate 16 in an operation configuration. As a result, the swivel plate 16 is secured to the support member 12 through the L-shaped member 28. In one embodiment, the nut 64 may be welded with the bolt 62 to prevent the nut 64 from unscrewing. Other locking methods such as a cotter pin can be used to secure the nut 64 to the bolt 62.

With reference to FIG. 1A-B, the guide member 40 including a guide hole 44 is attached to a free edge of the upright arm 34.

With reference to FIGS. 1A-C, the locking mechanism 30 selectively cooperates with one of the position holes 46, 48 of the swivel plate 16 for facilitating retaining of the swivel plate 16 in position during use of the hitch assembly 10. As a result, the locking mechanism helps releasably secure the swivel plate 16 to the support member 12 during use of the hitch assembly 10. The locking mechanism 30 includes an L-shaped locking rod 66 having a shaft portion 50 and a head portion 52 fixed to a tip end of the shaft portion 50, an aperture 70 extending transversely through a lower end of the locking rod 66, a retaining pin 72 sized to be retained in the aperture 70 and a biasing member 68.

As shown in FIGS. 1A and 1E, in one embodiment, the retaining pin 72 is a roll pin that is interference fit into the aperture 70. The positioning of the retaining pin 72 relative to the aperture 70 can be carried out by a hammer or other suitable tool.

The biasing member 68 can take various forms. As shown in FIG. 1E, in one embodiment, the biasing member 68 is in a form of a coil compression spring having an upper end and a lower end, where the diameter of the spring is larger than the diameter of the shaft portion 50 as well as the diameters of the guide holes 42, 44 respectively defined in the bottom arm 36 and guide member 40.

With reference to FIG. 1A, when the hitch assembly 10 is in use, the spring is disposed between the guide member 40 and the bottom arm 36 of the L-shaped member 28. The shaft portion 50 slidably extends through the guide hole 44 in the guide member 40, through the center of the spring, passes the guide hole 42 in the bottom arm 36 of the L-shaped member 28, passes a selected position hole 46 and passes out of the lower surface of the swivel member 16. The retaining pin 72, which has a length that is greater than the diameter of the spring, is then inserted into and extended through the aperture 70, with an upper surface engaging with a lower end of the spring and a lower surface engaging with an upper surface of the bottom arm 36 of the L-shaped member 28. The spring has a length that is greater than the distance between the lower surface of the guide member and the upper surface of the retaining pin 72. With this arrangement, after the retaining pin 72 is inserted into and extended through the aperture 70, the upper end of the spring continuously biases the lower surface of the guide member 40, while the lower end of the spring continuously biases the upper surface of the retaining pin 72.

As a result, when the locking mechanism 30 is locked in position, the swivel plate 16 is locked in place with respect to the support member 12 and is prevented from rotating relative to the support member 12.

To select a hitch connection member for coupling with a receiving member (not shown) on the trailer tongue of the trailer (not shown), the locking rod 66 is pulled upwardly in the direction of arrow A as shown FIG. 1B such that the locking rod 66 is removed from the position hole 46 in the swivel plate 16. The retaining pin 72 is raised along with the locking rod 66 toward the guide member 40 and the spring is compressed further by the retaining pin 72. Once the locking rod is removed from the position hole 46 or 48, the swivel plate 16 can rotate about the bolt 62 in the directions indicated by arrows B and C in FIG. 1B until the position hole of a desired wing is aligned with the guide holes 42, 44. For example, in FIGS. 1A-E, the first wing 18 is selected and the position hole 22 defined in the first wing 18 is aligned with the guide holes 42, 44. After the position hole 46 is aligned with the guide holes 42, 44, the restoring force of the spring pulls the retaining pin 72 and in turn pulls the locking rod 66 back down into the bottom arm guide hole 42, through the selected position hole 46 and passes out of the lower surface of the swivel plate 16. In this way, the selected wing 18 including a proper size hitch connection member 26 is locked into position for use.

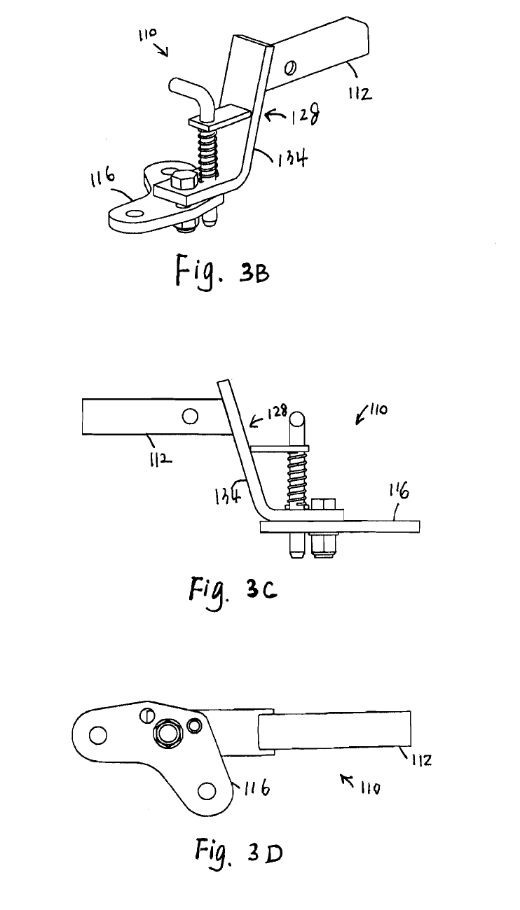

It will be appreciated that an L-shaped member with a different configuration can be used to position the swivel plate relative to the support member to enable desired positioning of the hitch connection members. That is, the hitch assembly may have a rise or drop to match the height of a hitch connection member with a trailer level. In one embodiment, as shown in FIGS. 3A-D, a support member 112 and a swivel plate 116 are in the same orientation as shown in FIGS. 1A-E, but the length of the upright arm of the L-shaped member has been extended upwardly. As show in FIG. 3A, the support member 112 is connected to an upper portion of the upright arm 134. This arrangement positions the swivel plate 116 at a different elevation with respect to the support member 112. As a result, the swivel plate 116 is positioned at a lower height above the ground. It is to be understood that the drop or raise of the swivel plate 116 can be any desired amount depending on the specific towing application.

As shown in FIGS. 3A-D, in one embodiment, the hitch assembly 110 includes a drop down of the swivel plate 116 relative to the support member 112. As a result, after connected to the towing vehicle (not shown), the hitch assembly 110 is at a location lower than the receiver on the towing vehicle. The embodiment in FIGS. 3A-D can be used with various vehicles, such as various golf cart utility vehicles and other all terrain vehicles. An example of a towing vehicle that may be equipped with the drop down hitch assembly 110 is a Cushman Turf Truckster™ utility vehicle available from Textron, Inc., Georgia, United States, where the hitch assembly when attached thereto may have a drop of 3½″ inches.

As shown in FIGS. 3A-D, in one embodiment, the L-shaped member 128 can also be oriented backwardly to prevent other parts of the towing vehicle from interfering with the operation of the hitch assembly.

The described embodiments are to be considered in all respects only as illustrative and not restrictive. The scope of the invention is therefore, indicated by the appended claims rather than by the foregoing description. All changes which come within the meaning and range of equivalency of the claims are to be embraced within their scope.

What is claimed is:

1. A hitch assembly, comprising:
a support member adapted to connect the hitch assembly to a vehicle;
a swivel plate having at least two wings, each wing including a hitch member hole extending through a thickness thereof, each hitch member hole being sized to allow a hitch connection member to be mounted thereto, the swivel plate being rotatable to allow a selected wing to move into a position for towing an object;
an L-shaped member securing the swivel plate to the support member; and
a locking mechanism being releasably engaged with the swivel plate for retaining the swivel plate in position.

2. The hitch assembly of claim 1, further comprising one or more hitch connection members.

3. The hitch assembly of claim 2, wherein each hitch connection member includes a ball portion and a shank portion.

4. The hitch assembly of claim 2, wherein each hitch connection member is removably secured to the swivel plate.

5. The hitch assembly of claim 4, wherein the hitch connection member is secured to the swivel plate via a threaded connection.

6. The hitch assembly of claim 1, wherein the swivel plate includes more than two wings each including a hitch member hole.

7. The hitch assembly of claim 6, wherein at least one hitch member hole is adapted for a generic usage other than for mounting a hitch connection member.

8. The hitch assembly of claim 1, wherein the swivel plate further includes an axle hole located approximately at a central portion of the swivel plate and at least two position holes each located on an opposite side of the axle hole relative to a respective hitch member hole.

9. The hitch assembly of claim 8, wherein a first axis extends through centers of the axle hole, one of the position holes and a respective one of the hitch member holes, and a second axis extends through centers of the axle hole, the other position hole and the other hitch member hole, an angle between the first and second axes being an obtuse angle.

10. The hitch assembly of claim 9, wherein the angle is approximately 120 degrees.

11. The hitch assembly of claim 1, wherein the locking mechanism includes a locking rod, an aperture adjacent to an end of the locking rod and extending transversely through the locking rod, a retaining pin sized to be retained in the aperture and a coil compression spring sized to allow the locking rod to extend through, when the hitch assembly is in use, an upper surface of the retaining pin continuously biases a lower end of the coil compression spring, and a lower surface of the retaining pin continuously biases the L-shaped member.

12. The hitch assembly of claim 11, wherein the retaining pin is retained in the aperture by interference fit.

13. The hitch assembly of claim 1, wherein the L-shaped member includes a first arm connected to the support member.

14. The hitch assembly of claim 13, wherein the first arm is positioned perpendicular to the support member.

15. The hitch assembly of claim 13, wherein the first arm is oriented in such a way that the first arm is inclined relative to the support member, the L-shaped member also including a second arm parallel to the support member and facing away from the support member, an angle between the first and second arms of the L-shaped member is an obtuse angle.

16. The hitch assembly of claim 13, wherein a length of the first arm varies to allow the swivel plate to be positioned at different elevations relative to the support member.

17. A method of using a hitch assembly, comprising:
selecting a hitch connection member and securing the hitch connection member to a wing of a swivel plate;
raising a locking rod of a locking mechanism such that a retaining pin of the locking mechanism is raised along with the locking rod and thereby the retaining pin compresses a spring of the locking mechanism;
rotating the swivel plate to allow a selected wing of the swivel plate to align with the locking rod and a support member that connects the hitch assembly to a vehicle;
releasing the locking rod such that the locking rod extends through a position hole defined in a thickness of the swivel plate and locking the swivel plate into position for use.
